(19) United States
(12) Patent Application Publication
(10) Pub. No.: US 2017/0186037 A1
(43) Pub. Date: Jun. 29, 2017

(54) SYSTEM AND COMPUTER PROGRAM PRODUCT FOR PROVIDING TARGETED MARKETING AND SALES, AND CONSUMER FIREWALL

(71) Applicant: Greg Brady, Dallas, TX (US)

(72) Inventor: Greg Brady, Dallas, TX (US)

(73) Assignee: One Network Enterprises, Inc., Dallas, TX (US)

(21) Appl. No.: 15/456,577

(22) Filed: Mar. 13, 2017

Related U.S. Application Data
(63) Continuation-in-part of application No. 14/020,249, filed on Sep. 6, 2013.

(51) Int. Cl. G06Q 30/02; H04L 29/06; G06Q 20/14; G06Q 10/08; G06Q 30/06

(52) U.S. Cl. CPC G06Q 30/0257; G06Q 30/0269; G06Q 10/083; G06Q 30/0635; G06Q 20/14; H04L 63/0245; H04L 63/102

(57) ABSTRACT

A system and computer program product for providing and managing a targeted online catalog. The system includes a plurality of remote computers, a central server, a network interface in communication with the central server and the plurality of remote computers over a network, and a shared database in communication with the central server. The central server is configured to collect user product data in a user profile from a user, collect vendor product data in a vendor profile from one or more vendors, collect authorized communication firewall data from the user, compare the user profile, authorized communication firewall data, and the vendor product data for identification of one or more vendors authorized to send communications the user, and present the user with one or more authorized communications based on the comparison. The user product data includes one or more categories of products of interest defined by the user. The vendor product data includes one or more categories of products offered for sale by the one or more vendors. The authorized communication firewall data includes a consumer contact list and a community list, each including an identification of one or more vendors authorized to send communications the user.

### CROSS REFERENCE TO RELATED APPLICATIONS

The present application is a continuation-in-part of and claims priority to U.S. patent application Ser. No. 14/020,249, entitled “System and Computer Product for providing targeted marketing and sales,” filed in the U.S. Patent and Trademark Office on Sep. 6, 2013, having at least one common inventor as the present document and hereby incorporated by reference.

### BACKGROUND OF THE INVENTION

Field of the Invention

The present invention is generally related to targeted marketing and sales, and more particularly to a system and computer program product for providing targeted marketing and sales, and consumer firewall.

Discussion of the Background

Marketing through the Internet is well known in the art. Individuals using the Internet are frequently presented with advertisements, promotions, and other content that is at least intended to be targeted to their demographic attributes, and individual characteristics. In a typical scenario, an advertiser, promoter or other entity selects a set of target demographics for its content and makes the content accessible to users either electronically or in printed form. However, whether a sale actually occurs with respect the marketed product and/or service depends on many factors, including the marketing content and the quality of the data collected for each user to determine such marketing content. Because this information is often collected based on indirect means, the products and/or services marketed are often not focused on the appropriate target audience and, instead, are often directed towards users who have no interest in the particular products and/or services being marketed and no sale occurs.

Thus, there currently exist deficiencies associated with targeted marketing and sales, and, in particular, with collecting detailed and accurate user information and matching that user information to categories of products which are being offered, promoted or sold which the user has an interest.

Further, online catalog systems which sell products and/or services on behalf of multiple entities are often not well integrated between the entites. For instance, the databases of these multiple entities and the entity providing the online catalog system are typically not shared. As such, there are real-time discrepancies between the inventory, sales, and shipping information contained in the separate databases used by these entities. Often no integrated shipping solution exists between these entities.

Thus, there currently also exist deficiencies associated with the management of online catalog systems and shipping of the products and/or services offered on such systems.

Further, consumers often search for products and/or services using the Internet using mail, websites, search engines, messaging and the like. Such consumer activities are often tracked and/or otherwise retained by the search provider, website operator and the like. Unfortunately, the consumer is often bombarded by marketing offers, advertisement, or other promotion relating to the products and/or services previously searched, using this tracked or retained information. Such tactics often overwhelm the consumer's email or otherwise distracts the consumer.

Thus, there currently also exist deficiencies associated with the consumer firewalls.

### SUMMARY OF THE INVENTION

Accordingly, one aspect of the present invention is to provide a system for providing and managing a communication firewall. The system includes a plurality of remote computers, a central server, a network interface in communication with the central server and the plurality of remote computers over a network, and a shared database in communication with the central server. The network interface is configured to provide and manage authorized communications. The central server is configured to collect user product data in a user profile from a user, collect vendor product data in a vendor profile from one or more vendors, collect authorized communication firewall data from the user, compare the user profile, authorized communication firewall data, and the vendor product data for identification of one or more vendors authorized to send communications the user, and present the user with one or more authorized communications based on the comparison. The user product data includes one or more categories of products of interest defined by the user. The vendor product data includes one or more categories of products offered for sale by the one or more vendors. The authorized communication firewall data includes a consumer contact list and a community list. The consumer contact list and the community list each include an identification of one or more vendors authorized to send communications the user.

Another aspect of the present invention is to provide a system for providing and maintaining an online catalog. The system includes a plurality of remote computers, a central server, a network interface in communication with the central server and the plurality of remote computers over a network, and a shared database in communication with the central server. The network interface is configured to provide and manage a targeted online catalog. The central server is configured to collect user product data in a user profile from a user, collect vendor product data in a vendor profile from one or more vendors, compare the user profile, including information derived from the user product data, to the vendor product data, present the user with content based on the comparison, automatically receive a payment from the user using the billing information if the automated billing option is enabled by the user, and automatically manage a shipment, using a shipping entity and the shipping information, to the user.

Yet another aspect of the present invention is to provide a computer program product embodied on a non-transitory computer readable medium for providing and maintaining a targeted online catalog. The computer program is implemented by one or more processors executing processor instructions. The computer program product includes (i) a first computer code for collecting user product data in a user profile from a user, (ii) a second computer code for collecting vendor product data in a vendor profile from one or more vendors, (iii) a third computer code for comparing the user profile, including information derived from the user product data, to the vendor product data, (iv) a fourth computer code for presenting the user with content based on the comparison, (v) a fifth computer code for automatically receiving a payment from the user, and (vi) a sixth computer code for automatically communicating a shipment instruction to a shipping entity. The user product data includes one or more categories of products of interest defined by the user and one or more special states defined by the user. The vendor product data includes one or more categories of products offered for sale by the one or more vendors and one or more special states defined by the one or more vendors in near real-time. The comparison ignores vendor product data that does match the one or more special states defined by the user. The content includes at least one selected from the group consisting of an advertisement, a promotion, and a discount for a product. The user profile includes billing and shipping information defined by the user. The billing and shipping information includes options to enable or disable automated billing and shipping. The fifth computer code for automatically receiving the payment from the user only occurs if the automated billing option is enabled by the user and uses the billing information. The sixth computer code for automatically communicating the shipment instruction only occurs if the automated shipping option is enabled by the user and includes the shipping information.

### BRIEF DESCRIPTION OF THE DRAWINGS

A more complete appreciation of the present invention and many of the attendant advantages thereof will be readily obtained as the same becomes better understood by reference to the following detailed description when considered in conjunction with the accompanying drawings, wherein:

FIGS. 1A-1B are block diagrams illustrating a system for providing targeted marketing and sales, and consumer firewall in accordance with an embodiment of the present invention;

FIGS. 2A-2M are flow charts illustrating a method for providing targeted marketing and sales, and consumer firewall in accordance with an embodiment of the present invention; and

FIG. 3A-3D illustrate exemplary user interfaces for providing targeted marketing and sales, and consumer firewall in accordance with an embodiment of the present invention.

### DETAILED DESCRIPTION OF THE PREFERRED EMBODIMENTS

Referring now to the drawings, wherein like reference numerals designate identical or corresponding parts throughout the several views, preferred embodiments of the present invention are described.

The present invention provides a system and computer program for delivering targeted marketing, sales and online catalog to Internet users, including users of mobile phone technologies, PDAs, messaging technologies, and the like. According to at least one embodient retailers, promoters and/or advertisers are provided with the ability to offer promotions to users that have opted to receive promotions, advertisements or offers for sale in specific purchasing categories which the user has indicated an interest. Thus, a retailer, promoter and/or advertiser may target specific users according to what they are actually interested in, and not simply by demographic statistics that merely predict what a typical user (sometimes referred to herein as a “consumer”) in a given category may possibly want to purchase. This type of focused marketing may provide the retailer, promoter and/or advertiser with more confidence that their marketing efforts will provide a greater success rate in increasing consumer traffic to their establishments and/or promotions, and increase their sales of products and/or services.

Because every person and every business may have a different opinion on what categories they should be considered, the present invention may provide a vendor the ability to define their own marketable boundaries and categories. Users, through their selections may provide without limitation a geographic region, what purchasing categories they have an interest, a start and end time frame(s) (which may be repeated), a product status and the like. Vendors may thus target users within whatever categories, regions and time frames in which the users have an established interest.

According to at least one embodiment of the present invention, the user provides information regarding the categories in which the user has an interest in purchasing. This information may include a region and a timeframe. The collected data is used to create a user profile to target specific content to the user. When selecting content to display to the user, the system automatically selects the content that best matches the user's interest determined using the user profile. In addition, on certain web pages, electronic media and/or printed materials, content that best matches may be displayed more prominently to the user than other content displayed on the web page, electronic media and/or printed material. Each of the above, is designed to increase sales.

The user profile may also be used to create personalized advertisements, marketing materials, entertainment, or educational materials tailored for an individual user. The present invention may provide this one-to-one relationship not only in advertising, but likewise in assessing user loyalty, and may enable a company to have real time data on individualized purchasing patterns for specific consumers, which may then reveal to the retailer when a user abandons usage of, or changes preferences for, particular products. Businesses may engage in more targeted promotions, thus expediting of the movement of merchandise and the effectiveness of its marketing efforts. Thus, the present invention may provide traceable data to retailers for determining the effectiveness of their individual promotions and their ability to build and maintain loyal consumers. Such data may provide retailers, promoters and/or advertisers with the ability to strategically plan for future sales.

Further, according to at least one embodiment of the present invention, targeted marketing and sales may be provided at a significantly lower cost than conventional market analysis and sales systems, due to the accuracy of the information collected, and the use of automated billing and shipping. Because advertising schemes may be localized to a category that the user already has an interest, businesses may determine which market they wish to target and may compare results from different markets. Periodic surveys and/or questionnaires may also be available through the present invention to solicit user feedback data. It should be evident to those skilled in the art that any existing market analysis model may be incorporated into or used in combination with the present invention to enhance the quality of the marketing analysis system.

According to at least one embodiment of the present invention, a user may create or utilize an existing notification and streaming-based web site and/or targeted online catalog. The web site and/or targeted online catalog allows the user to configure only those products and/or services which the user has an interest using any Internet connected device, such as without limitation, a computer, laptop, cell phone, PDA, network device, and the like. The information provided regarding the products and/or services can be pulled through queries or pushed based on notification alerts using without limitation a time based workflow, real time streaming, and the like, or limit the products and/or services provided on a targeted online catalog

The system also allows a user to define special states in which that product and/or service should be in before there is an interest by the user, such as without limitation a promotional activity, a discount, a special state and the like. For example, a user may only be interested in Louis Vuitton® purses when there is an upcoming or ongoing sales promotion for the purse, or when the purse is sold below a certain discount percentage from the normal price or below a certain threshold price. Once the purse reaches the user-defined special state, a communication may be automatically transmitted to the user by the system using any known means including a streaming message or notification communicated to the user or the user's web site. The message may include without limitation a special offer for the product and/or service. Depending on who streamed the promotion, the message may also include without limitation physical or virtual location details. For example, the message may include the physical location of a retail location, the web address of a particular web site, or other vendor information. Further, the message may include one or more hyperlinks or scannable codes (such as a bar code) that the user may utilize to complete the sale. Alternatively, once the user-defined special state is reached, the purse may then the displayed on the targeted online catalog. The user may use the system to specify, without limitation, the products and/or services they care about, the type of promotions they want to see and where the products and/or services may be available, as well as other filtering criteria.

The user may use the system to control what advertising will be allowed to communicate with the user's web site and/or targeted online catalog. For example, the user may use the system to specify that the user is only interested in new advertisements for a particular new pair of sun glasses or a next generation television soon to be made available.

According to at least one embodiment, the system establishes a true many-to-many multi-party service that allows retailers, promoters and/or advertisers to easily onboard their products and/or services and specify new states of the products and/or services. For example, the retailers, promoters and/or advertisers may set the state to, without limitation, a new product introduction, a product on promotion, a limited product availability, a discontinued product and/or service, and the like. The system may include a search criteria to allow the user to configure the types of products, services and advertisements they want to allow and where. The system may be configured such that the vendor may provide new promotion information using a simple web service in near real-time. The vender may also configure the necessary fulfillment activities that are required in order to deliver the products to the user. For example, the vendor may specify that the product is only available for pick up at a particular retail location. The system may also be configured to automatically create outbound web service messages to retailers for product reservations.

The system may include integration with major parcel and less than load (LTL) trucking carriers as well as white glove delivery services. The system may further integrate and manage the shipment of a product and/or service using multiple shipping entities. The vendor and/or user may specify shipping options, such as without limitation, overnight parcel shipping, two or three day shipping, delivery to a home or office, delivery time(s), and the like. Multiple products may also be configured to be shipped as a single shipment to a home, office or other location. Further, all of the tracking events from source to delivery may be communicated to the user using any known communication means or using the user's web site as described herein.

### I.Targeted Online Catalog System

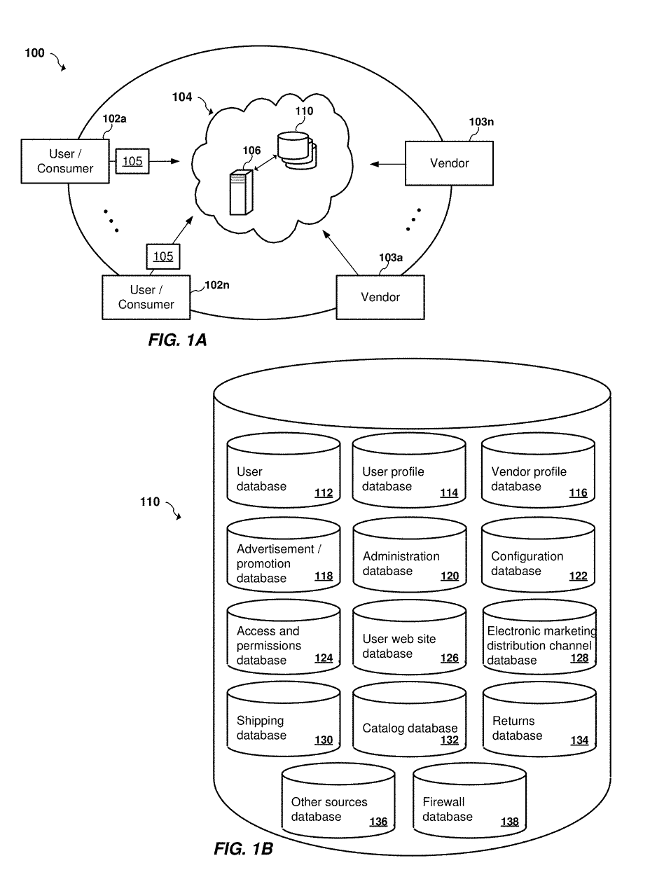

Referring to FIGS. 1A-1B, block diagrams illustrating a system 100 for providing targeted marketing and sales, and consumer firewall in accordance with an embodiment of the present invention is shown. The system 100 includes one or more computers and/or servers 106 in communication with one or more databases 110. According to one embodiment, the one or more databases 110 include, without limitation, a user database 112, a user profile database 114, a vendor profile database 116, an advertisement/promotion database 118, an administration database 120, a configuration database 122, an access and permissions database 124, a user web site database 126, an electronic marketing distribution channel database 128, a shipping database 130, a catalog database 132, a returns database 134, a firewall database 138, and an other sources database 136. It is understood, however, that other databases and/or combinations thereof are possible within the scope of the present invention and that the above databases are provided for exemplary purposes.

Individuals/entities accessing the system 100 include, without limitation, one or more system administrators, one or more users (102a-102n), one or more vendors (103a-103n), and the like. According to one embodiment, the one or more system administrators, one or more users (102a-102n), and the one or more vendors (103a-103n) access the system 100 via network 104 using an interface device. The interface device may include without limitation a computer, laptop, PDA, smart phone, server, network device, and the like. The network may include without limitation the Internet, Intranet, LAN or WAN, other proprietary network, and the like. The one or more system administrators, one or more users (102a-102n), and the one or more vendors (103a-103n) may utilize a web browser or other software to communicate with the system 100.

The one or more system administrator, one or more users (102a-102n) and the one or more vendors (103a-103n) may access to the system 100 using a secure socket connection to a web server running on the system 100. A web-based graphical user interface allows the one or more users (102a-102n), and the one or more vendors (103a-103n), having the appropriate permission, to access the user interfaces and modules of the system 100 or portions thereof. One or more system administrators use the administration and configuration module 250 to assign appropriate permissions to the one or more users (102a-102n) and the one or more vendors (103a-103n).

According to at least one embodiment, at least a portion of the one or more databases 110 is shared by one or more internal and/or external entities associated with the targeted online catalog. According to this embodiment, the system 100 may be connected to both external entities, such as manufacturers and distributors, and internal entities, such as sales and marketing. At least a portion of these entities share at least a portion of the one or more databases 110. Through the system 100, the entities may share data and information through the shared one or more databases 110, schedule and maintain shipping of products and/or services offered on the targeted online catalog, and minimize inventory, for each entity. The system 100 includes one or more programs that include various application tools for inventory control, shipping, purchasing, accounting, and the like. Because the prior art utilizes separate databases for multiple collaborating entities, their data is often stale or out of date. Using this embodiment of the present invention, real-time discrepancies between the inventory, sales, and shipping information may be eliminated. In addition, shipping of the products and/or services offered on the targeted online catalog, may be assigned to multiple shipping entities to handle different segments of the shipping. Thereby, these multiple shipping entities may be seamlessly integrated into a more comprehensive shipping network.

### II. Targeted Online Catalog Processing

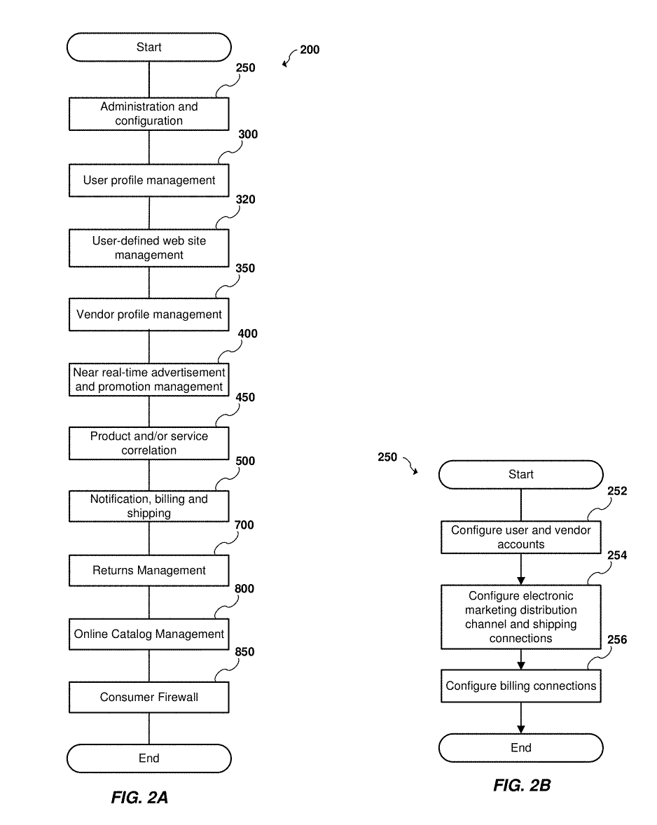

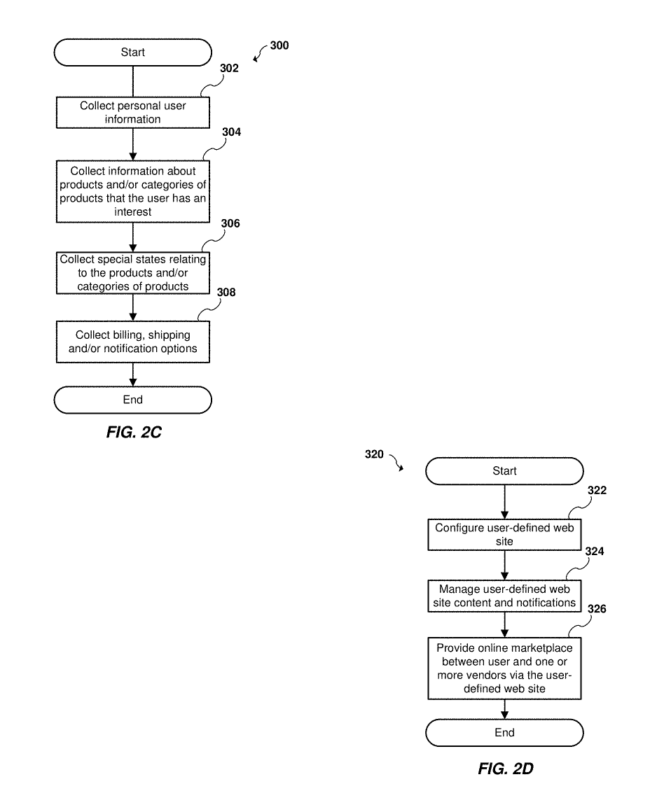

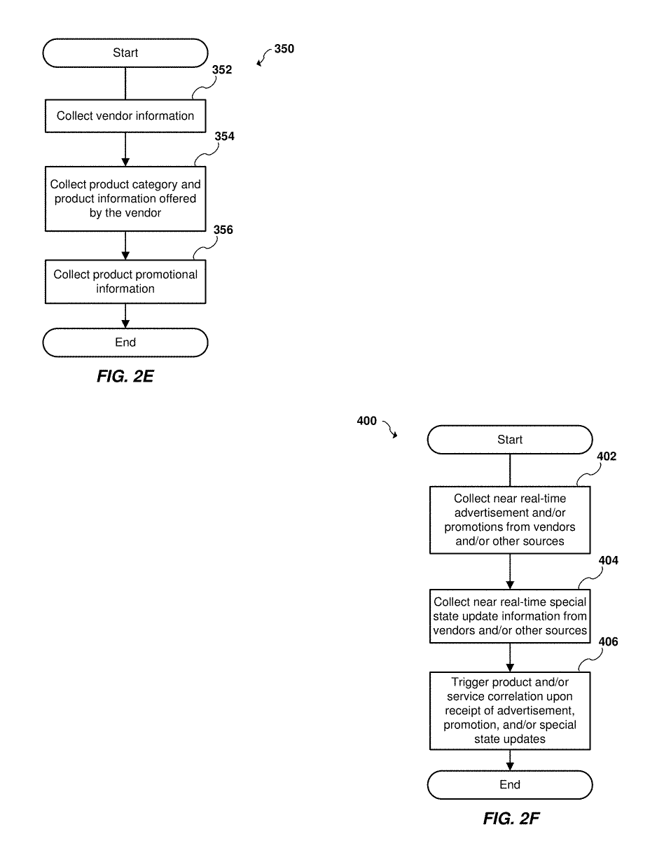

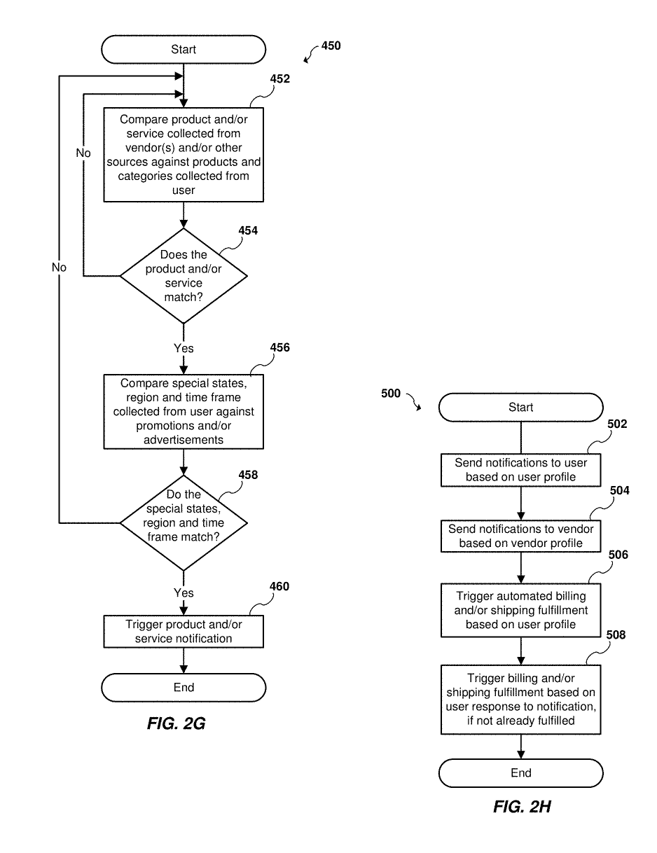

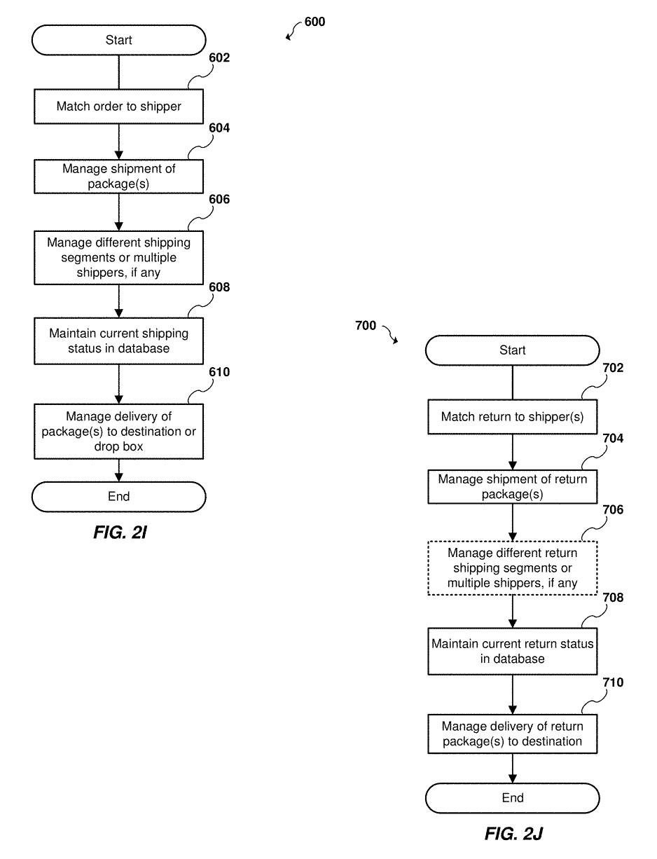

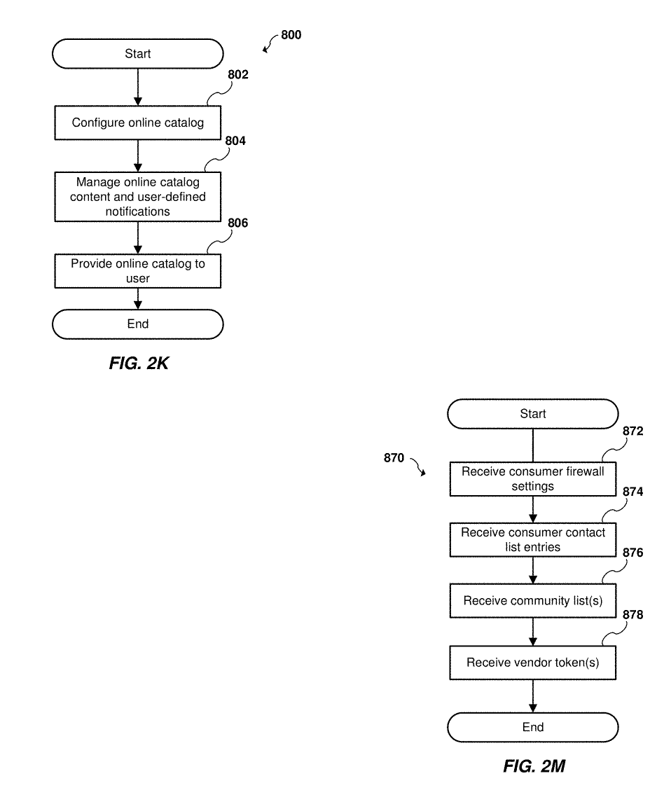

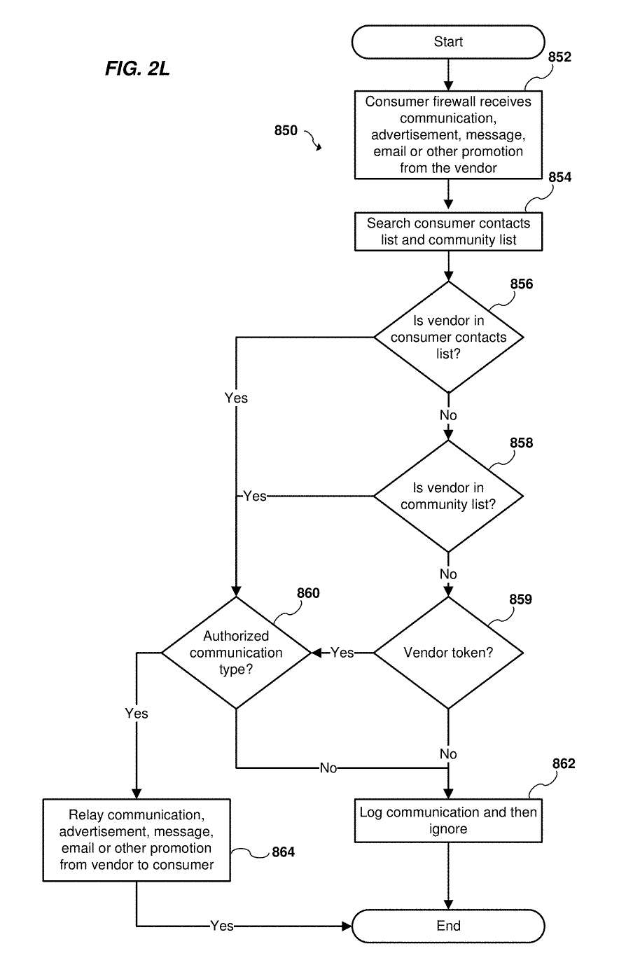

Referring to FIGS. 2A-2K, flow charts illustrating a method for providing targeted marketing and sales, and consumer firewall in accordance with an embodiment of the present invention, are shown. The system 100 includes, without limitation, modules for (i) administration and configuration 250, (ii) user profile management 300, (iii) user-defined web site management 320, (iv) vendor profile management 350, (v) near real-time advertisement and promotion management 400, (vi) product and/or service correlation 450, (vii) notification, (viii) billing and shipping management 500, (ix) returns management 700, and (x) online catalog management 800. It is understood that these modules may be accessed in any order and that other modules and/or combinations thereof are possible within the scope of the present invention.

### Administration and Configuration Module

Referring to FIG. 2B, a flow chart illustrating the administration and configuration module 250 for providing targeted marketing and sales, and consumer firewall in accordance with an embodiment of the present invention, is shown. At block 252, the user and vendor accounts are configured. The configuration includes, without limitation, setting up login accounts, passwords and access permissions for one or more users (102a-102n) and one or more vendors (103a-103n) to different user interfaces and portions of the system 100. According to one possible implementation, the user and vendor account login and password information are stored in the user database 112, and the user and vendor access and permissions are stored in the access and permissions database 124.

At block 254, electronic marketing distribution channel and shipping connections are collected and configured. This configuration includes, without limitation, electronically linking the system 100 with electronic marketing distribution channels for communicating to the user the promotions and/or advertisements relating to the products and/or services which the user has expressed an interest. For example, the system 100 may be configured to work with, without limitation, pay per click (PPC) advertising networks, cost per mille (CPM) advertising networks, direct banner advertising networks, text link marketplaces and networks, affiliate marketplaces and networks, monetization widgets, sponsored reviews and paid blogging networks, RSS feed advertisements, pop-up and pop-under networks, and the like, to provide targeted promotions and/or advertisements to the user based on what products and/or services the user 102 has indicated an interest using one of the user interfaces of the system 100. The system 100 may also be integrated with an online catalog system as described herein. PPC advertising networks include, without limitation, Google Adsense, Yahoo! Publisher Network (YPN), BidVertiser, Chitika, Clicksor, and the like. PPC advertising networks include, without limitation, Casale Media, Burst Media, Value Click, Advertising.com, Tribal Fusion, Right Media, and the like. Text link marketplaces and networks include, without limitation, DigitalPoint Link Sales Forum, Text-Link-Brokers, TNX, LinkWorth, and the like. Affiliate marketplaces and networks include, without limitation, Commission Junction, ClickBank, Azoogle Ads, Link Share, and the like. Monetization widgets include, without limitation, WidgetBucks, ScratchBack, SmartLinks, and the like. Sponsored reviews and paid blogging networks include, without limitation, PayPerPost, Sponsored Reviews, ReviewMe, BlogVertise, Smorty, and the like. RSS feed advertisements include, without limitation, Feedburner, BidVertiser, and the like. Pop-up and pop-under networks include, without limitation, Tribal Fusion, PayPopup, PopupAd, Adversal, and the like. The promotions and/or advertisements communicated to the user by those electronic marketing distribution channels could be configured to provide only those products and/or services in which the user 102 has an interest that are within a region or time frame and/or match a special status, as defined by the user 102. Thereby, the effectiveness of those existing electronic marketing distribution channels may be improved. According to one possible implementation, the electronic marketing distribution channel information is stored in the electronic marketing distribution channel database 128.

The configuration may also include, without limitation, linking the system 100 with shipping fulfillment channels for shipping the products and/or services which the user expressed an interest. Shipping fulfillment channels may include, without limitation, major parcel and LTL carriers, white glove delivery services, and the like. According to one possible implementation, the shipping fulfillment channel information is stored in the shipping database 130. Other shipping information, such as without limitation, vendor and/or user defined shipping options and tracking information may be stored in the shipping database 130, the user profile database 114 and/or the vendor profile database 116 as appropriate.

At block 256, billing connections are collected and configured. This configuration includes, without limitation, electronically linking the system 100 with credit card processing entities, such as without limitation, Visa, MasterCard, PayPal, banking institutions, and the like.

### User Profile Management Module

Referring to FIG. 2C, a flow chart illustrating the user profile management module 300 for providing targeted marketing and sales, and consumer firewall in accordance with an embodiment of the present invention, is shown. At block 302, personal user information is collected from the user. Personal information may include, without limitation, the user's name, shipping address, billing address, web site or online social media addresses, email address, phone number, birthday information, credit card or other payment information, and the like. The products and/or services and/or categories of products and/or services that the user 102 has an interest, are collected, at block 304. This information may be provided, without limitation, using online surveys, questionnaires, and the like, or by drilling down through graphical or textual categories provided by the user interfaces of the system 100 to select one or more products and/or services or general areas of interest to the user. At block 306, special states, starting and ending time frame(s), regional information, and the like, relating to the products and/or categories of products and/or services are collected from the user 102. Optionally, the starting and ending time frame(s) may be specified by the user 102 as repeating, such as without limitation, every month, quarter, year, and the like. The starting time(s) may include a future time and date when the user 102 is interested in purchasing a particular product and/or service. For example, the user 102 may specify that a starting time should begin two months from the current date. Because the billing and shipping may be automated as detailed herein, the user 102 could expect that a product and/or service matching the user's interest or search criteria would be purchased and shipped in approximately two months. Further, because the starting and ending time frame(s) may be specified as repeating, this feature might be used for replenishment of a particular product.

At block 308, billing, shipping options and notification options are collected. The user 102 may control, without limitation, whether the user 102 wishes to enable or disable automated billing and/or shipping, and the like. Notification options may include whether the user 102 wants to receive notifications using, without limitation, the user's web site, a targeted online catalog, popups, pop-unders, text messages, online social media, email, electronic marketing distribution channels, mailing address, and the like.

According to one possible implementation, the user defined personal user information, billing options, shipping options, notification options, product and/or services information, special states, and the like, are stored in the user profile database 114. Other information relating to the user including, without limitation, historical purchasing information, demographic information, and the like, may also be stored in the user profile database 114.

### User-Defined Web Site Management Module

Referring to FIG. 2D, a flow chart illustrating the user-defined web site management module 320 for providing targeted marketing, sales and a targeted online catalog in accordance with an embodiment of the present invention, is shown. An optional user-defined web site is configured for the user 102, at block 322. The system may automatically or manually configure the user web site and/or targeted online catalog using input from a system administrator the user 102 or a combination of both. According to one possible implementation, the user 102 selects from a list of web-site templates for the general design of the user-defined web site.

The user 102 may control, without limitation, whether the user 102 wishes to receive notifications on the user's web site, what content, including products and/or services, advertisements, will be allowed to communicate with the user's web site and/or displayed on targeted online catalog, and whether the user 102 wishes to allow comparison shopping and/or reverse bidding from multiple vendors.

The user web site may be hosted locally by the system 100 on the one or more computers and/or servers 106, or hosted remotely on one or more computers and/or servers external to the system 100, as specified by the system administrator or the user 102 or a combination of both. According to one possible implementation, the user web site configuration and customization information is stored in the user web site database 126. At block 324, the user-defined content and notifications are managed by the system 100. At block 326, an online marketplace between a user and one or more vendors is managed by the system 100. This may occur within the user-defined web site and/or the targeted online catalog (using the notification, billing and shipping module 500). The online marketplace may include an area for comparison shopping and/or reverse bidding from multiple vendors, along with streaming video, audio or text feeds relating to the products and/or services that the user 102 has expressed an interest, and/or information about the vendors (103a-103n) that sell or offer for sale such products and/or services.

According to one non-limiting alternate implementation, the user web site is configured to be used by a user 102 as their primary web site and may be accessed by third parties to see content provided by the user 102 using templates configured by the user 102. As such, the user 102 is motivated to use the system 100 not only for the benefits described herein, but also for the purpose of maintaining their own personal web site.

### Vendor Profile Management Module

Referring to FIG. 2E, a flow chart illustrating the vendor profile management module 350 for providing targeted marketing and sales, and consumer firewall in accordance with an embodiment of the present invention, is shown. At block 352, vendor information is collected from the vendor 103. Vendor information may include, without limitation, the vendor's 103 entity name, retail location(s), web site and/or online social media information, special shipping information, vendor preferences and options, and the like. The products and/or services and/or categories of products and/or services that the vendor 103 offers for sale is collected, at block 354. The one or more vendors (103a-103n) are provided a user interface on the system 100 where they can onboard their products and/or services to the system 100. At block 356, special states, promotion starting and ending time frame(s), regional information, pricing information, and the like, relating to the products and/or categories of products and/or services, are collected from the vendor 103. The one or more vendors (103a-103n) may also configure the necessary fulfillment activities that are required in order to deliver the products to the user 102. For example, the one or more vendors (103a-103n) may specify that the product is only available for pick up at a particular retail location.

According to one possible implementation, the vendor information, vendor preferences and options, product and/or services information, and special states, fulfillment activities and the like, are stored in the vendor profile database 116. Other information relating to the vendor 103, such as without limitation, notification information and customer satisfaction information may also be stored in the vendor profile database 116. Notification information may include whether the vendor 103 wants to receive notifications using, without limitation, the vendor's web site, popups, text messages, online social media, email, mailing address, and the like.

### Real-Time Advertisement and Promotion Management Module

Referring to FIG. 2F, a flow chart illustrating the near real-time advertisement and promotion management module 400 for providing targeted marketing and sales, and consumer firewall in accordance with an embodiment of the present invention, is shown. At block 402, near real-time advertisement and/or promotions from vendors (103a-103n) and/or other sources is collected. Near real-time special state update information from vendors (103a-103n) and/or other sources is collected, at block 404. The special state may be set to, without limitation, a new product introduction, a product on promotion, a limited product availability, a discontinued product and/or service, and the like.

The information collected from the vendors (103a-103n) and/or other sources relating to the advertisement and/or promotions may be collected (blocks 402 and 402) by any means including extracting the information from the vendors' (103a-103n) and/or other sources' web sites automatically, or by the vendor 103 provided information by logging into the system 100 and either entering this information manually using an online user interface provided by the system 100 or by uploading a data file containing such information. Using user interfaces provided by the system 100, the system 100 may be configured by a system administrator to either collect this information (i) continuously, (ii) at pre-defined times, and/or (ii) upon the occurrence of an update to any portion of the information provided by a vendor 103 using the user interfaces provided by the system 100. The collection of information relating to the advertisement and/or promotions and advertisement and/or promotions may include, without limitation, searching the databases 110 of the system 100 for products and/or services or the categories of products and/or services offered by the one or more vendors (103a-103n), or by searching the Internet, other networks, and the like. According to one embodiment, web robots, spiders, and the like may be utilized to search the Internet or other network for advertisements and/or promotions, and special state update information, from vendors (103a-103n) and/or other sources. As discussed above, these technologies may be configured to run periodically, based upon some event, and/or manually activated by a system administrator.

The data file may utilize any now known or future data formats, including without limitation data objects, SQL statements, XML, ASCII or proprietary data files, and the like. The data file may be automatically pushed or pulled between the system 100 and the vendor's database and/or computer system, or a third party maintaining such information. According to one possible implementation, the information relating to the advertisement and/or promotions, and the special state update information, from vendors (103a-103n) and/or other sources is stored in the advertisement/promotion database 118, and additional information relating to the other sources is stored in the other sources database 136.

At block 406, the product and/or service correlation is automatically triggered upon the system 100 receiving one or more advertisement, promotion and/or special state update.

### Correlation Module

Referring to FIG. 2G, a flow chart illustrating the product and/or service correlation module 450 for providing targeted marketing and sales, and consumer firewall in accordance with an embodiment of the present invention, is shown. At block 452, the product and/or service information collected from the vendors (103a-103n) and/or other sources is compared against the products and/or category information collected from the user 102. Both exact match and fuzzy logic comparisons may be utilized. If there is a match, then processing continues at block 456. If there isn't a match, then then processing continues to loop through the other comparisons. At block 456, special states, region, and time frame information collected from the user 102 are compared against the promotions and/or advertisements collected from the vendors (103a-103n) and/or other sources. Both exact match and fuzzy logic comparisons may be utilized. If there is a match, then processing continues at block 460. If there isn't a match, then processing continues to loop through the other comparisons. At block 460, the notification, billing and shipping management module 500 may be triggered if one or more matches were found.

### Targeted Online Catalog Management Module

Referring to FIG. 2K, a flow chart illustrating the catalog management module 800 for providing targeted marketing and sales, and consumer firewall in accordance with an embodiment of the present invention, is shown. The targeted online catalog is configured for the user 102, at block 802. The system may automatically or manually configure the targeted online catalog using input from a system administrator the user 102 or a combination of both. According to one embodiment, the configuration includes an automatic item creation capability to flow on boarding to the targeted online catalog described herein and into Alibaba and Amazon catalogs. Thereby, the present invention is a one stop service that vendors can easily use.

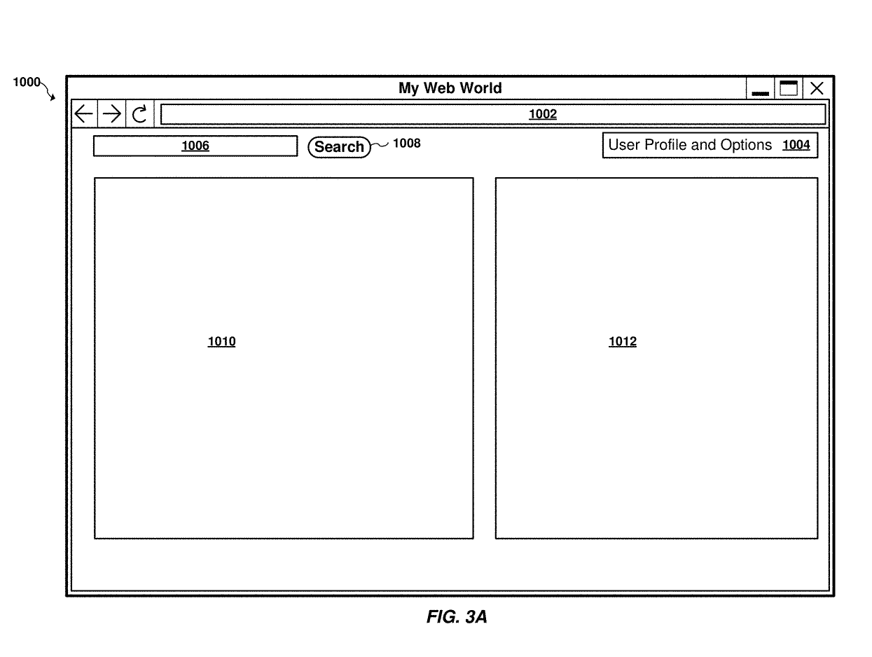

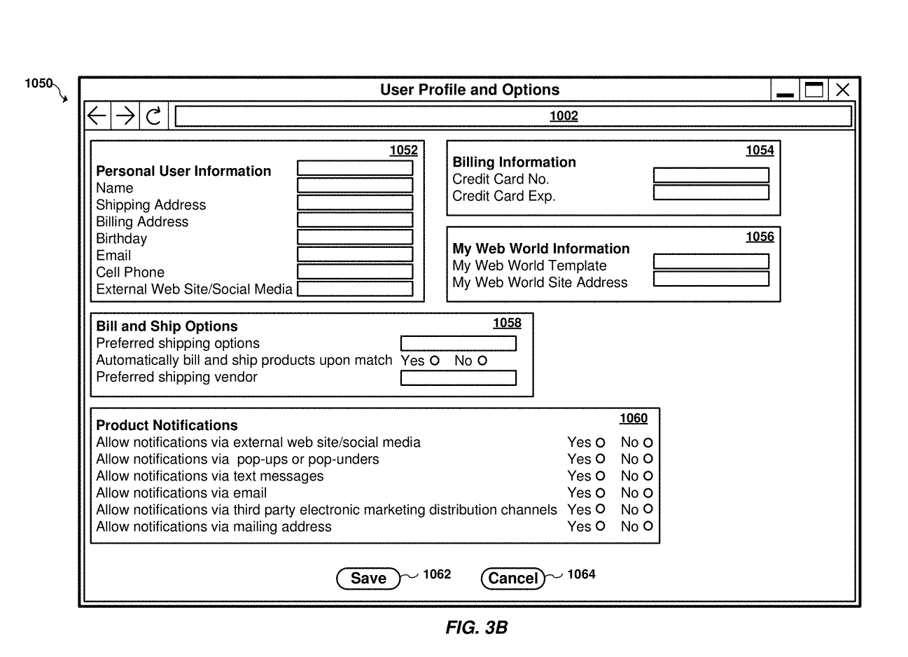

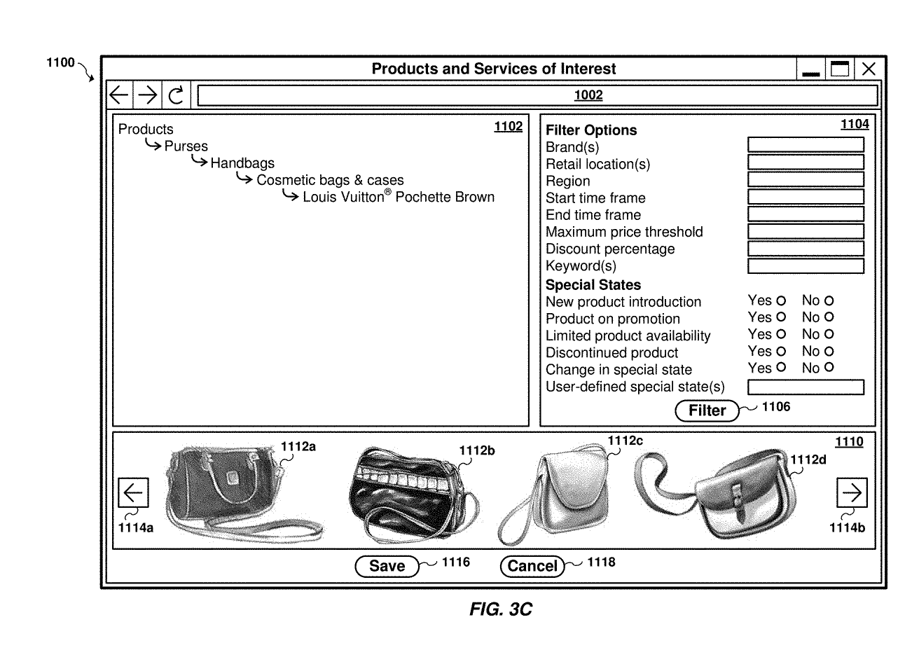

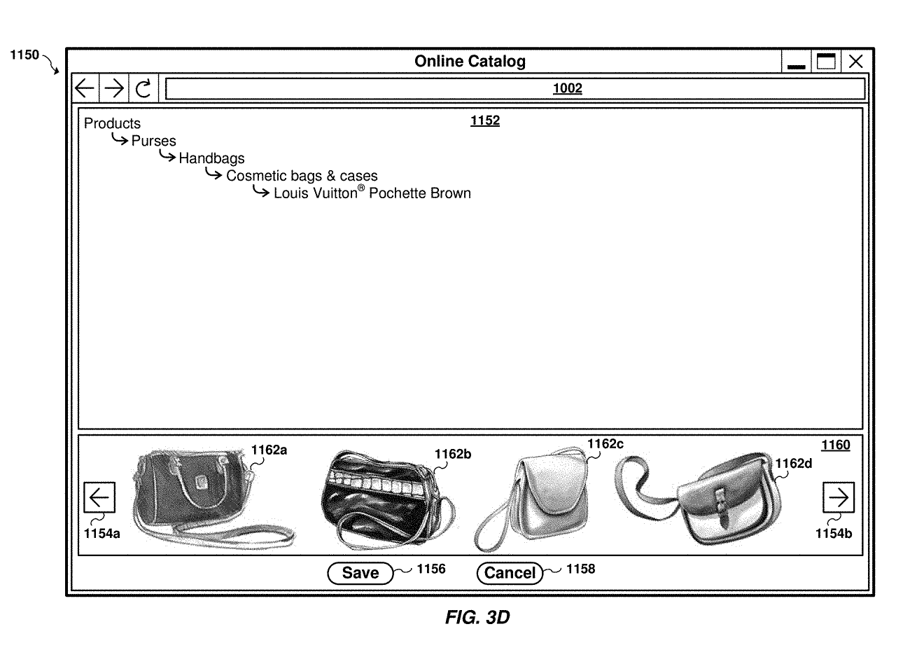

The user 102 may control, without limitation, what content will be allowed to be displayed, and whether the user 102 wishes to allow comparison shopping and/or reverse bidding from multiple vendors. According to one embodiment, the targeted online catalog content is determined by user-defined filter options, such as those described herein with respect filter options 1104 in FIG. 3C.

The targeted online catalog may be hosted locally by the system 100 on the one or more computers and/or servers 106, or hosted remotely on one or more computers and/or servers external to the system 100, as specified by the system administrator or the user 102 or a combination of both. At block 804, the targeted online catalog content is managed by the system 100. The targeted online catalog may include an area for comparison shopping and/or reverse bidding from multiple vendors, along with streaming video, audio or text feeds relating to the products and/or services that the user 102 has expressed an interest, and/or information about the vendors (103a-103n) that sell or offer for sale such products and/or services.

According to one embodiment, vendors may promote their respective brands without competitive comparison directly to the consumer. Vendors may create their own marketing sites within the online catalog for direct sales with the vendor. This gives the vendor brand and direct marketing support.

According to one embodiment, vendors may post their items on to the online catalog. The items are tagged and searchable with a user-defined profiling capability to define what information is provided to the user such that the user does not get bombarded with marketing which is the biggest problem with the internet today.

According to one embodiment, the system 100 includes ATP, order promising, logistics including all last mile and white glove, an international parcel network and logistics service.

### Notification, Billing and Shipping Management Module

Referring to FIGS. 2H-2I, flow charts illustrating the notification, billing and shipping management module 500 for providing targeted marketing and sales, and consumer firewall in accordance with an embodiment of the present invention, is shown. At block 502, one or more product and/or service match notifications are communicated to the user 102 based on the user profile configuration and whether the user wants to receive such notifications. One or more product and/or service match notifications are communicated to the vendors (103a-103n) based on their respective vendor profiles, at block 504.

Match notifications may be communicated using, without limitation, a web site, a targeted online catalog, popups, text messages, online social media, email, electronic marketing distribution channels, mailing address, and the like. Match notifications may include, without limitation, the matching products and/or services offered or promoted by the one or more vendors (103a-103n), the states of those products and/or services, any promotion information associated with those products and/or services, and the necessary fulfillment activities. Further, the match notification may include one or more hyperlinks or scannable codes (such as a bar code) that the user 102 may utilize to complete the sale.

The notification information may be arranged by the system 100 to facilitate comparison shopping information and/or reverse auctions. For example, based on the products and/or services of interest to the user 102, multiple offers from multiple vendors (103a-103n) may be present directly to the user 102 using the user interface 1000. This allows the user to compare the different vendor 103 offerings and select a particular vendor 103 offering that best matches the need of the user 102. Further, multiple vendors (103a-103n) may be directed by the user 102 offer the user 102 their lowest bid and the lowest offer may be either manually selected by the user 102 or automatically by the system 100. The notification information may also include customer satisfaction information or other vendor related information designed to allow the user 102 to make the best decision regarding the purchase.

A vendor 103 may opt-in to participate in the comparison shopping and/or reverse bidding arrangement using the user interfaces of the system 100. Using the user interfaces provided by the system 100 (such as, without limitation, the user-defined web site), the one or more users (102a-102n) may directly collaborate and negotiate with the one or more vendors (103a-103n) using any known or future communication means, or the user's web site and/or targeted online catalog. For example, a vendor 103 may utilize the user interfaces provided by the system 100 to offer a different price for delayed delivery or a different shipment methodology (two packages instead of one, etc.). Further, a user 102 may utilize the user interfaces provided by the system 100 to specify a price that must be offered by the vendor 103 in order for there to be a match (e.g., “I'll buy it for $x negotiations.”). Using the user interface of the system 100, the user 102 may directly communicate with a representative of a particular vendor 103 using a live video, audio and/or chat connection.

At block 506, the system 100 may automatically bill and/or ship the products and/or services based upon whether the user 102 has enabled respectively automatic billing and/or automatic shipping in the user profile (using block 308 of the user profile management module 300). If the billing and/or shipping fulfillment did not already occur in the previous step (block 506), then the system 100 may automatically bill and/or ship the products and/or services based upon the user's 102 response to a match notification, at block 508. For example, without limitation, the user 102 may click one or more hyperlinks or scan one or more scannable codes (such as a bar code) that may be contained within the match notification to complete the sale.

At block 602, the system 100 matches the order to a shipper. The shipment of package(s) is managed, at block 604. At block 606, any different shipping segments or multiple shippers, if any, are managed. The system 100 maintains the current shipping status in the database, at block 608. At block 610, the system manages the delivery of package(s) to its intended destination or drop box. Drop boxes may be strategically located around the world and used to store package(s).

Depending upon the configuration, the system 100 may ship the products and/or services using major parcel, less than load (LTL) trucking carriers, and/or white glove delivery services. The products and/or services may be shipped based upon vendor 103 and/or user 102 specified shipping options, including without limitation, overnight parcel shipping, two or three day shipping, delivery to a home or office, delivery time(s), and the like. Multiple products may also be configured to be shipped as a single shipment to a home, office or other location, using the user interfaces of the system 100. The system 100 may also integrate and manage the shipment of a product and/or service using multiple shipping entities. Further, all of the tracking events from source to delivery may be communicated to the user 102 using any known communication means or using the user's web site as described herein.

Accordingly, as described above, the information collected from the vendors (103a-103n) and/or other sources relating to the advertisement and/or promotions may be (i) collected in near real-time (using the near real-time advertisement and promotion management module 400), (ii) searched for matching user-desired products and/or services (using the correlation module 450 described below), and (iii) pushed to the appropriate one or more users (102a-102n) (using the notification, billing and shipping management module 500 described below). Further, the system 100 may be configured by the appropriate one or more users (102a-102n) to bill the respective users (102a-102n) and ship the products and/or services automatically.

As such, the present invention provides a multi-party real-time/streaming system that allows for promised availability, delivery and spot negotiation of goods between a consumer and multiple brands/manufacturers.

### Returns Management Module

According to one embodiment, a returns management module 700 manages consumer returns on behalf of the supplier or vendor. Referring to FIG. 2J, a flow chart illustrating the returns management module 700 for providing targeted marketing and sales, and consumer firewall in accordance with an embodiment of the present invention, is shown. At block 702, the return is automatically or manually assigned to a shipper. The shipment of the return package(s) is managed, at block 704. At block 706, any different shipping segments or multiple shippers, if any, are managed. The system 100 maintains the current return status in the database, at block 708. At block 710, the system manages the delivery of the return package(s) to its intended destination. Optionally, drop boxes may be strategically located around the world and used to store returned package(s) as the intended destination.

### Consumer Firewall Module

Consumers often search for products and/or services using the Internet using mail, websites, search engines, messaging and the like. Such consumer activities are often tracked and/or otherwise retained by the search provider, website operator, and the like. Unfortunately, the consumer is often bombarded by marketing offers, advertisement, or other promotion relating to the products and/or services previously searched, using this tracked or retained information. Such tactics often overwhelm the consumer's email, webpage usage or otherwise distracts the consumer. According to one embodiment, a consumer firewall module 850 filters and manages communications received from a vendor as described below.

Referring to FIGS. 2L and 2M, flow charts illustrating the consumer firewall module 850 for configuring and providing targeted marketing and sales, and consumer firewall in accordance with an embodiment of the present invention, is shown. Without limitation, FIG. 2M illustrates the administrative aspects of the consumer firewall module 850 and FIG. 2L illustrates the filtering provided by the consumer firewall module 850.

As shown in FIG. 2M, the system receives one or more consumer-defined firewall settings and stores these settings in firewall database 138, at block 872. The consumer firewall settings may be predefined with commonly configured settings. The consumer firewall settings may also include filtering levels (e.g., None, Low, Medium or High) providing increasingly more stringent filtering rules based on the filtering levels. At block 874, the system receives one or more consumer contact list entries and stores these entries in firewall database 138. The consumer contact list entries may include without limitation authorized email addresses, IP addresses, aliases, and the like. The system receives one or more community list entries and stores these entries in firewall database 138, at block 876.

As shown in FIG. 2L, the consumer firewall module 850 receives a communication, advertisement, message, email or other promotion (herein “communication”) from one or more vendors, at block 852. At block 854, a search is performed for the vendor responsible for sending the communication is in the consumer contact list and the community list. At block 856, if the particular vendor is in the consumer contact list, then processing continues at block 860. If the vendor does not match an entry in the consumer contact list, then processing continues at block 858. At block 858, if the vendor is in the community list, then processing continues at block 860. If the vendor does not match an entry in the community list, then processing continues at block 859. At block 859, if token exists for the vendor, then processing continues at block 860. If a token does not exist for the vendor, then the communication is not authorized, and is logged and then ignored, at block 862. At block 860, if the particular type of communication from one or more vendors is authorized, then processing continues at block 864. At block 864, the authorized communication is relayed from the vendor to the relevant consumer.

In addition to other filtering provided by the consumer firewall module 850, the system may optionally filter based content. Filtering content is a way to recognize unwanted communications by analyzing the content of the communication. A communication that contains certain key word(s), phrases or word patterns may be determined as unauthorized. Authentication may be also be accomplished by authentication of the sender (or source). Authenticating the source of the communication is done by verifying that the domain name of the source and the IP address of the source match as registered. Authentication of the source may also include, without limitation, (RMX) reverse mail exchange, (SPF) sender permitted from (SPG), (DMP) designated mailers protocol, sender ID framework (Microsoft), and “DomainKeys” domain-level authentication framework (Yahoo), and the like.

### III. Exemplary User Interfaces

Referring to FIGS. 3A-3D, exemplary user interfaces for providing targeted marketing and sales, and consumer firewall in accordance with an embodiment of the present invention, are shown. As shown in FIG. 3A, the user interfaces may include, without limitation, a search area (as represented by text field 606 and button 608), a user profile and options pull down or menu option 1004, a web page content area 1010 and a product and/or services match notification area 1012. The search area (1006 and 1008) allows the user 102 to search for products and/or services, and/or make other queries with the system 100, the Internet and/or other network. The user profile and options pull down or menu option 1004 is configured to allow the user 102 to configure their user profile and to specify options and preferences on their user web site as described above. The web page content area 1010 may provide web content defined by the user 102 and/or the system administrator. For example, the web content may include, without limitation, news information, user-defined content, information about specific products, services, vendors (103a-103n) and/or other sources, or may operate as a web portal for the user 102. The information about specific products, services, vendors (103a-103n) and/or other sources may include comparison shopping information and or reverse auction information. For example, based on the products and/or services of interest to the user, multiple vendors (103a-103n) may present multiple offers directly to the user 102 using the user interface 1000 so that the user may compare the different vendor 103 offerings and select an particular vendor 103 offering that best matches the need of the user 102. Further, multiple vendors (103a-103n) may be directed by the user 102 to offer the user 102 their lowest bid and the lowest offer may be manually selected by the user 102 or automatically selected by the system 100.

The product and/or services match notification area 1012 may include text or graphical information relating to the product and/or services. Products and/or services from multiple vendors (103a-103n) and/or other sources may be displayed for comparison shopping purposes, and clicking on one products and/or services in the product and/or services match notification area 1012 may result in additional detail being displayed in the web page content area 1010 relating to the selected products and/or services. Content that best matches the product and/or services match notification area 1012 may be displayed more prominently to the user than other content displayed on the user web page. Further, according to an alternative embodiment, vendors (103a-103n) may pay a service fee to have their products and/or services displayed more prominently than products and/or services offered by other vendors (103a-103n). It is understood that the user interface shown in FIG. 3 is shown for exemplary purposes and that other arrangements are obviously possible within the scope of the present invention.

As shown in FIG. 3B, the user interfaces may include, without limitation, a personal user information section 1052, a billing information section 1054, a user-defined web site section 1056, a bill and ship options section 1058, and a product notifications section 1060. The personal user information section 1052, may include, without limitation, the user's name, shipping address, billing address, web site or online social media addresses, email address, cell and/or phone number, birthday information, and the like. The billing information section 1054 may include, without limitation, credit card or other payment information, and the like. The user-defined web site section 1056 may include, without limitation, the web site address, template used to create the web site, other customization information, and the like. The bill and ship options section 1058 may include, without limitation, preferred shipping options, an option to allow products and/or services to be billed and shipped automatically upon a match, preferred shipping vendor information, other billing and shipping information, and the like. The product notifications section 1060 may include, without limitation, whether the user 102 wants to receive notifications using, without limitation, the user's web site, popups, pop-unders, text messages, online social media, email, electronic marketing distribution channels, mailing address, and the like.

As shown in FIG. 3C, the user interfaces may include, without limitation, a filter section 1104, a hierarchical category drill down selection section 1102, and a graphical selection section 1110. The filter section 1104 may include one or more filter options, such as without limitation, by brand(s), vendor(s) (103a-103n), vendor 103 retail location(s), region, start and end time frame(s), maximum price threshold, discount percentage, keyword(s), and the like. The hierarchical category drill down selection section 1102 may be configured to allow the user to drill down through graphical or textual categories to select one or more products and/or services or general areas of interest to the user. The graphical selection section 1110 may be configured to allow the user to select products and/or services or general areas of interest to the user simply by selecting a graphical representation of a category, product and/or service. One or more fields may also be included to for the user to provide a unique name associated with the product and/or service match request. Alternatively, a unique name may be automatically generated by the system 100.

As shown in FIG. 3D, an online catalog user interface may include, without limitation, a display section 1152, and a graphical selection section 1160. The online catalog may optionally include a filter section 1104 (as shown and described with respect to FIG. 3). the display section 1152 may, without limitation, include a hierarchical category drill down selection section (similar to FIG. 3C) which may be configured to allow the user to drill down through graphical or textual categories to select one or more products and/or services or general areas of interest to the user. The graphical selection section 1160 may be configured to allow the user to select products and/or services or general areas of interest to the user simply by selecting a graphical representation of a category, product and/or service. One or more fields may also be included to for the user to provide a unique name associated with the product and/or service match request. Alternatively, a unique name may be automatically generated by the system 100.

Using the system 100 detailed above, a true many-to-many multi-party service may be established between the one or more users (102a-102n) and the one or more vendors (103a-103n).

### IV. Other Modifications and Variations

While the present invention has been described with reference to one or more particular embodiments, those skilled in the art will recognize that many changes may be made thereto without departing from the spirit and scope of the present invention. Each of these embodiments and obvious variations thereof is contemplated as falling within the spirit and scope of the claimed invention, which is set forth in the following claims.

This invention may be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As will be appreciated by one of skill in the art, the invention may be embodied as a method, device, or computer program product. Accordingly, the present invention may take the form of an entirely hardware embodiment or an embodiment combining software and hardware aspects all generally referred to herein as a “circuit” or “module.”

The present invention thus includes a computer program product which may be hosted on a computer-usable storage medium having computer-usable program code embodied in the medium and includes instructions which perform the processes set forth in the present specification. The storage medium can include, but is not limited to, any type of disk including floppy disks, optical disks, CD-ROMs, magneto-optical disks, ROMs, RAMs, EPROMs, EEPROMs, flash memory, magnetic or optical cards, or any type of media suitable for storing electronic instructions.

Computer program code for carrying out operations of the present invention may be written in an object oriented programming language such as Java®, Smalltalk, C# or C++. However, the computer program code for carrying out operations of the present invention may also be written in conventional procedural programming languages, such as the “C” programming language or in a visually oriented programming environment, such as VisualBasic.

The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Obviously, many other modifications and variations of the present invention are possible in light of the above teachings. The specific embodiments discussed herein are merely illustrative, and are not meant to limit the scope of the present invention in any manner. It is therefore to be understood that within the scope of the disclosed concept, the invention may be practiced otherwise then as specifically described.

1. A system for providing and managing a communication firewall, the system comprising:
a plurality of remote computers;
a central server;
a network interface in communication with the central server and the plurality of remote computers over a network, the network interface being configured to provide and manage a targeted online catalog;
a shared database in communication with the central server;
wherein the central server is configured to:
collect user product data in a user profile from a user, the user product data comprising one or more categories of products of interest defined by the user;
collect vendor product data in a vendor profile from one or more vendors, the vendor product data comprising one or more categories of products offered for sale by the one or more vendors;
collect authorized communication firewall data from the user, wherein the authorized communication firewall data includes a consumer contact list and a community list, wherein the consumer contact list and the community list each include an identification of one or more vendors authorized to send communications the user;
compare the user profile, authorized communication firewall data, and the vendor product data for identification of one or more vendors authorized to send communications the user; and
present the user with one or more authorized communications based on the comparison.

2. The system of claim 1, wherein only the authorized communications specified by the user is presented to the user.

3. The system of claim 1, wherein the central server is further configured to receive one or more tokens from the one or more vendors, and wherein the comparison includes comparing the one or more tokens.

4. The system of claim 1, wherein only the one or more authorized communications specified by the user is presented to the user.

5. The system of claim 1, wherein the central server is further configured to collect one or more special states defined by the user;

6. The system of claim 5, wherein the one or more special states defined by the user comprise a starting or ending date.

7. A system for providing and managing a targeted online catalog, the system comprising:
a plurality of remote computers;
a central server;
a network interface in communication with the central server and the plurality of remote computers over a network, the network interface being configured to provide and manage authorized communications;
a shared database in communication with the central server;
wherein the central server is configured to:
collect user product data in a user profile from a user, the user product data comprising one or more categories of products of interest defined by the user, the user profile includes shipping information and billing information defined by the user, the billing information includes an option to enable or disable automated billing;
collect vendor product data in a vendor profile from one or more vendors, the vendor product data comprising one or more categories of products offered for sale by the one or more vendors;
compare the user profile, including information derived from the user product data, to the vendor product data;
present the user with online catalog content based on the comparison;
automatically receive a payment from the user using the billing information if the automated billing option is enabled by the user; and
automatically manage a shipment, using a shipping entity and the shipping information, to the user.

8. The system of claim 7, wherein only the online catalog content specified by the user is presented to the user.

9. The system of claim 7, wherein user product data further comprises one or more special states defined by the user, and wherein the comparison ignores vendor product data that does match the one or more special states defined by the user.

10. The system of claim 9, wherein the one or more special states defined by the user comprise a starting or ending date.

11. The system of claim 9, wherein the one or more special states defined by the user comprise a geographic region.

12. The system of claim 9, wherein the one or more vendors receive a communication when the vendor product data matches the one or more special states defined by the user.

13. The system of claim 7, wherein the vendor product data further comprises one or more special states defined by the one or more vendors in near real-time.

14. The system of claim 9, wherein the one or more special states comprise at least one selected from the group consisting of a new product introduction, a product promotion activity, a limited product availability, a discontinued product and a discount for the product.

15. The system of claim 14, wherein the discount comprises a discount percentage from a regular price of the product.

16. The system of claim 14, wherein the discount comprises a discounted price of the product.

17. The system of claim 7, wherein the user profile includes billing and shipping information, and wherein the communication includes the billing and shipping information.

18. A computer program product embodied on a non-transitory computer readable medium for providing and managing a targeted online catalog, wherein the computer program is implemented by one or more processors executing processor instructions, the computer program product comprising:
a first computer code for collecting user product data in a user profile from a user, the user product data comprising one or more categories of products of interest defined by the user and one or more special states defined by the user, wherein the user profile includes billing and shipping information defined by the user, the billing and shipping information includes options to enable or disable automated billing and shipping;
a second computer code for collecting vendor product data in a vendor profile from one or more vendors, the vendor product data comprising one or more categories of products offered for sale by the one or more vendors and one or more special states defined by the one or more vendors in near real-time;
a third computer code for comparing the user profile, including information derived from the user product data, to the vendor product data, wherein the comparison ignores vendor product data that does match the one or more special states defined by the user;
a fourth computer code for presenting the user with content based on the comparison, wherein the content comprises at least one selected from the group consisting of an advertisement, a promotion, and a discount for a product;
a fifth computer code for automatically receiving a payment from the user using the billing information if the automated billing option is enabled by the user; and
a sixth computer code for automatically communicating a shipment instruction, including the shipping information, to a shipping entity if the automated shipping option is enabled by the user.
